(19) United States
(12) Patent Application Publication
(10) Pub. No.: US 2026/0254927 A1
(43) Pub. Date: Aug. 27, 2026

(54) COMMUNICATING VISUAL MEDIA FOR DEVICES LOCATED IN A ZONE

(71) Applicant: Motorola Mobility LLC, Chicago, IL (US)

(72) Inventors: Amit Kumar Agrawal, Bangalore (IN); Panduranga Reddy Pailla, Bangalore (IN); Vijayprakash Idlur, Bangalore (IN)

(73) Assignee: Motorola Mobility LLC, Chicago, IL (US)

(21) Appl. No.: 19/060,927

(22) Filed: Feb. 24, 2025

(51) Int. Cl. H04N 7/18; G06T 7/73; H04M 1/72439; H04W 64/00; H04W 76/20

(52) U.S. Cl. CPC H04N 7/183; G06T 7/73; H04W 64/006; H04W 76/20; G06T 2207/30232; H04M 1/72439

(57) ABSTRACT

A first device may obtain visual media, including images, videos, and screenshots, of one or more items at a first location. The first device may store the visual media in a data store at the first device, such as a personal knowledge base. In some examples, the first device may detect a second device at a second location, where the second location may be a zone (i.e., a smart zone) that corresponds to a category of item. For example, the zone may be a particular type of store, such as a grocery store. Based on detecting the second device at the second location, the first device may recall the visual media from the data store. If the visual media depicts items of the category that corresponds to the zone (e.g., food items corresponding to the grocery store), then the first device may communicate the visual media to the second device.

### BACKGROUND

As technology has advanced our uses for computing devices have expanded. One such use is storing images and other visual media on mobile electronic devices, such as smartphones. However, storing and recalling such visual media on mobile devices is not without its problems. One such problem is a situation in which a user may have to sort through large numbers of images before finding a desired image, or a user attempting to look for an image and realizing the user never took the image. These problems can be frustrating for users, leading to wasted time.

### BRIEF DESCRIPTION OF THE DRAWINGS

Embodiments of communicating visual media for devices located in a zone are described with reference to the following drawings. The same numbers are used throughout the drawings to reference like features and components:

FIG. 1 illustrates an example system for communicating visual media for devices located in a zone, as discussed herein;

FIGS. 2 and 3 illustrate example operations of the techniques discussed herein;

FIGS. 4 and 5 illustrate examples of items in accordance with the techniques discussed herein;

FIG. 6 illustrates an example of visual media storage in accordance with the techniques discussed herein;

FIGS. 7 and 8 illustrate examples of visual media recall in accordance with the techniques discussed herein;

FIG. 9 illustrates an example process for implementing the techniques discussed herein in accordance with one or more embodiments;

FIG. 10 illustrates various components of an example electronic device that can implement embodiments of the techniques discussed herein.

### DETAILED DESCRIPTION

Communicating visual media for devices located in a zone is discussed herein. Generally, when a user goes shopping (e.g., for groceries, clothing, household items, or other items), the user may keep a list of what they need and a schedule of where to go to purchase the items to ensure the user remembers everything they need. The user may write the list on paper or record the list using a mobile device (e.g., a smartphone). However, users' busy schedules and the wide variety of products in stores may introduce challenges to the shopping experience. For example, if a user forgets the list, it may be difficult to remember all the items the user intended to purchase. Even if the user has the list, it may be easy to forget essential items that may not have been written down or misjudge quantities or brands needed. In some cases, the user may take an image or a video of the items they have at home (e.g., in their refrigerator or pantry) to refer to while shopping. However, the user may have to sort through many images to find the one they are looking for, and the image may not show items clearly or may lack the complete context the user needs. Such challenges may lead to multiple shopping trips, wasted time, and overspending on unnecessary items.

In contrast to traditional shopping lists, the techniques discussed herein support communicating visual media (e.g., images, videos, and other media) to electronic devices (e.g., mobile devices) located at a given smart zone. A first device (e.g., a smartphone, a tablet) may obtain visual media of one or more items at a first location. For example, a user may take and store an image of their pantry (e.g., the first location) on a smartphone, where the image may depict any number of food items that are in the pantry. The first device may store the image in a data store, which may be referred to herein as a personal knowledge base.

The first device may be connected to a second device (e.g., a smartphone) via a wireless connection that may enable the first and second devices to communicate with each other. In some examples, the first device may detect a second device at a second location, which may be a smart zone. A smart zone is a digitally-enabled area within a store that may create interactive shopping experiences, and each smart zone may correspond to particular items or categories of items. For example, the second device may be located in a smart zone that corresponds to a grocery store, or more specifically, the produce department of the grocery store. Based on detecting that the second device is in the smart zone, which corresponds to the category of the one or more items at the first location, the first device may recall the visual media from the data store and communicate the visual media to the second device. For example, if the second device is located in the produce section of the grocery store which is a smart zone, then the first device may communicate the image of the pantry so that a user of the second device knows what is missing from the pantry and thus, what they need to purchase, instead of relying on a list.

The techniques discussed herein improve the operation of a computing device by helping users seamlessly identify goods they may actually intend to purchase when the user is at a specified smart zone (e.g., in a shopping complex). For example, instead of a device storing large amounts of images, videos, text files (e.g., lists), and other data users may rely on for shopping, the techniques discussed herein may allow a user to recall only visual media that is pertinent to a specific shopping trip, which may improve efficiency and reduce memory requirements. The discussed techniques may save users time by reducing the number of shopping trips, the time it may take to make lists, and the time it may take to locate lists while shopping.

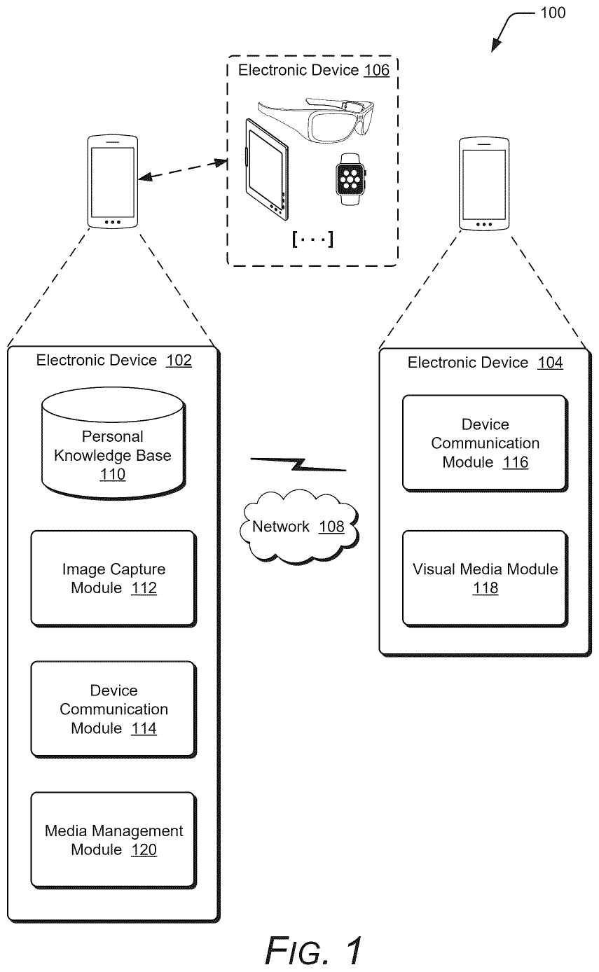

FIG. 1 illustrates an example system 100 implementing the techniques discussed herein. The system 100 may include an electronic device 102 (e.g., a first device) an electronic device 104 (e.g., a second device), and an electronic device 106 (e.g., a third device), which can be, or include, many different types of computing or electronic devices. For example, the electronic device 102 and the electronic device 104 can be at least one of a smartphone or other wireless phone, a camera (e.g., compact or single-lens reflex), or a tablet or phablet computer. By way of further example, the electronic device 106 can be a notebook computer (e.g., netbook or ultrabook), a laptop computer, a wearable device (e.g., a smartwatch, an augmented reality (AR) headset, glasses, or other device, or a virtual reality (VR) headset, glasses or other device), a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, an automotive computer, and so forth.

In some implementations, the electronic device 102 may be connected to the electronic device 106 through a wired or wireless connection (e.g., Internet, Bluetooth). The electronic device 106 may be a camera (e.g., compact or single-lens reflex), a wearable device such as a smartwatch, an AR headset, glasses, or other device, or a VR headset, glasses or other device, a personal media player, a personal navigating device (e.g., global positioning system), an entertainment device (e.g., a gaming console, a portable gaming device, a streaming media player, a digital video recorder, a music or other audio playback device), a video camera, an IoT device, an automotive computer, and so forth. The electronic device 106 may be enabled to capture images, videos, or other visual media of items in the vicinity of the electronic device 106.

The electronic device 102 and the electronic device may each include a display. The display can be configured as any suitable type of display, such as an organic light-emitting diode (OLED) display, active matrix OLED display, liquid crystal display (LCD), in-plane shifting LCD, projector, and so forth. The display may be implemented as part of the electronic device 102 and the electronic device 104, or the display may be implemented separately from the electronic device 102 and the electronic device 104. In such situations, the electronic device 102 and the electronic device 104 can communicate with the display via any of a variety of wired (e.g., Universal Serial Bus (USB), IEEE 1394, High-Definition Multimedia Interface (HDMI)) or wireless (e.g., Wi-Fi, Bluetooth, infrared (IR)) connections. The display can also optionally operate as an input device (e.g., the display can be a touchscreen display).

The electronic device 102 and the electronic device 104 may also each include a processing system that includes one or more processors, each of which can include one or more cores. The processing system may be coupled with, and may implement functionalities of, any other components or modules of the electronic device 102 and the electronic device 104 that are described herein. In one or more embodiments, the processing system includes a single processor having a single core. Alternatively, the processing system includes a single processor having multiple cores or multiple processors (each having one or more cores).

The electronic device 102 and the electronic device 104 may also each include an operating system. The operating system manages hardware, software, and firmware resources in the electronic device 102 and the electronic device 104. The operating system manages one or more applications running on the electronic device 102 and the electronic device 104, and operates as an interface between applications and hardware components of the electronic device 102 and the electronic device 104.

The electronic device 102 may include a personal knowledge base 110 (e.g., a data store), which may be a storage device implemented using any of a variety of storage technologies, such as magnetic disk, optical disc, Flash or other solid state memory, and so forth. In some examples, the personal knowledge base 110 may implement functionality to deliver personalized responses to queries from a user. For example, if a user queries the personal knowledge base 110 for an image of a particular category of item, the personal knowledge base 110 may be equipped to locate the queries data and respond to the user with the data. In some implementations, the personal knowledge base 110 may be stored on a remote server (e.g., in the cloud), where the electronic device 102 may still manage the personal knowledge base 110.

In some examples, the electronic device 102 and/or the electronic device 106 may include an image capture module 112. The image capture module 112 captures images digitally using any of a variety of different technologies, such as a charge-coupled device (CCD) sensor, a complementary metal-oxide-semiconductor (CMOS) sensor, combinations thereof, and so forth. The image capture module 112 can include a single sensor and lens, or alternatively multiple sensors or multiple lenses. For example, the image capture module 112 may have at least one lens and sensor positioned to capture images from the front of the computing device 102 (e.g., the same surface as the display is positioned on), and at least one additional lens and sensor positioned to capture images from the back of the computing device 102.

The image capture module 112 can capture still images as well as video. The visual media content discussed herein refers to one or both of still images and video, or any other type of captured visual media. The captured images or video are stored in the personal knowledge base 110.

The electronic device 102 may also include a device communication module 114 that implements functionality to detect when the electronic device 102 is connected to the electronic device 104 and to communicate with the electronic device 104 (e.g., send and receive various signals, data, and so forth). Similarly, the electronic device 104 includes a device communication module 116 that implements functionality to detect when the electronic device 104 is connected to the electronic device 102 and to communicate with the electronic device 102 (e.g., send and receive various signals, data, and so forth). The electronic devices 102 and 104 can be connected to one another using one or more of a wired or wireless connection. The electronic devices 102 and 104 can be directly connected to one another (e.g., with no intermediary device or system) or indirectly connected to one another (e.g., via one or more other devices or systems such as a router, switch, hub, wireless access point, and so forth).

Such communication can take various forms, such as voice calls (e.g., over a cellular system, public switched telephone network (PSTN), network (e.g., using voice over Internet Protocol (VoIP), etc.), short messaging service (SMS) messages, multimedia messaging service (MMS) messages, email, group based chat messaging system, and so forth. This communication can be carried out over a network 108, which can be any of a variety of different networks 108, including the Internet, a local area network (LAN), a public telephone network, a cellular network (e.g., a third generation (3G) network, a fourth generation (4G) network, a fifth generation (5G) network), an intranet, other public or proprietary networks, combinations thereof, and so forth. The electronic device 102 and the electronic device 104 can thus communicate with other devices wirelessly and accordingly is also referred to as a wireless device. In some examples, the electronic device 102 and the electronic device 104 may be a part of a group of trusted devices, or may share credentials to a same account (e.g., family member devices).

In some implementations, the electronic device 102 may communicate visual media to the electronic device 104 via the device communication module 114 and the device communication module 116. The electronic device 104 may include a visual media module 118 that may receive and process the visual media. For example, the visual media module 118 may implement functionality to display the visual media to a user via a display, which may allow the user to compare the visual media to items in the user's vicinity.

The current user of the electronic device 102 or the electronic device 104 is referred to as the current user that is in possession of the electronic device 102 or the electronic device 104, or the user that is currently in possession of the electronic device 102 or the electronic device 104. A user being in possession of the electronic device 102 or the electronic device 104 refers to a user that is physically in control of or currently accessing the electronic device 102 or the electronic device 104. For example, the user that is holding the electronic device 102 or the electronic device 104 (e.g., with his or her hand) is the current user that is in possession of the electronic device 102 or the electronic device 104.

In ordinary situations, a first user may go grocery shopping at a second location (e.g., a particular shopping complex that currently has multiple discounts). The first user may not have a list of items they wish to purchase, and may have difficulty remembering which grocery items they are out of and identifying the correct grocery items (e.g., brands, variants, etc.) to purchase. In such cases, the first user may call a second user (e.g., a spouse) who is at the users' house and request the second user to relay which items are stocked in the kitchen and which items need to be purchased. The first user may make several phone calls to the second user or other users of the household in this way. After purchasing the items and returning home, the first user may realize they forgot some items, or the second user may realize some incorrect (e.g., different brand or variety) or not-needed items were purchased. To prevent such miscommunication, the techniques discussed herein provide for communication of visual media of items to devices located in smart zones.

In one or more implementations, a user may utilize the system 100 when shopping for items such as groceries, clothing, household items, and so forth. The user with the electronic device 102 and the electronic device 106, if connected to the electronic device 102, may be located in a first location. The first location may be the user's house, for example. More specifically, the first location may be a room of the user's house (e.g., a kitchen, a garage, a bathroom, a bedroom, and so forth)), or may be a particular area or element of that room (e.g., a storage closet, an open refrigerator, grocery or storage cupboards, a pantry, work areas, stationary cupboards or drawers, and so forth). The electronic device 102 may obtain visual media of one or more items at the first location. For example, if the first location is a kitchen of the user's house, the electronic device 102 may obtain images of food in the pantry of the kitchen. In some examples, the electronic device 102 may capture the images using the image capture module 112.

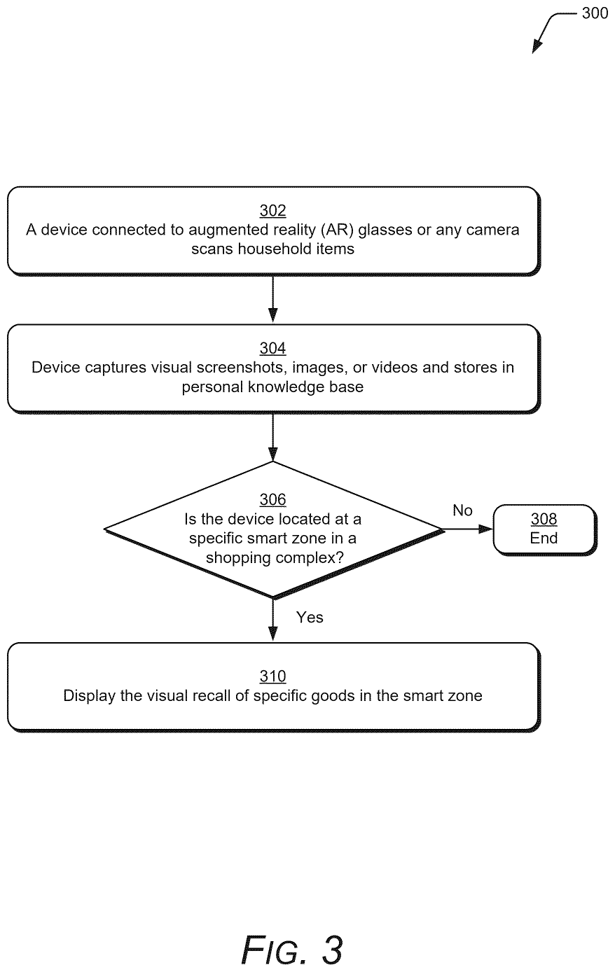

Additionally, or alternatively, the electronic device 102 may receive the images from the electronic device 106, which may have captured the images using a component similar to the image capture module 112 or via some other means. In some cases, the electronic device 102 may be detected at the first location (e.g., “at home”) and may be connected to the electronic device 106. As an example, the images may depict the food items in the pantry. Additional examples of the images are provided with reference to FIGS. 3-7. In some implementations, the electronic device 102 or the electronic device 106 may continuously monitor or scan the first location for one or more items.

In response to obtaining the visual media, a media management module 120 may store the visual media in the personal knowledge base 110. For example, the media management module 120 may store images, videos, visual screenshots, or other visual media content in the personal knowledge base 110.

In some implementations, the media management module 120 may detect the electronic device 104 at a second location. For example, while a first user of the electronic device 102 may be located at the first user's house, a second user of the electronic device 104 may be located at a grocery store, as the second user may be going shopping. The second location may be a smart zone, which may enable the electronic device 102 to detect the electronic device 104. The media management module 120 can detect that the electronic device 104 is at the second location in any of a variety of manners. For example, the electronic device 104 may communicate an indication to the electronic device 102 that the electronic device 104 is at the second location, may communicate an indication to the electronic device what smart zone the electronic device 104 is located at (e.g., a geographical location of the electronic device 104, an indication of one or more categories of items are associated with the smart zone).

A smart zone (also referred to as an experience center) may be a digitally-enabled area within a store, shopping mall, or other retail space that utilizes sensors, real-time data, and automation to create a personalized, efficient, and interactive shopping experience. Smart zones may utilize technologies such as Ultra-Wideband (UWB), Bluetooth beacons, and AR for virtual try-ons (e.g., for clothing) and product demos. For example, UWB-capable tags anchored to chosen locations) may enable users to trigger specific apps or settings, effectively creating zones by placing multiple tags throughout an area (e.g., their home). Such technologies may co-exist with “Find My Device” features of the electronic device 102, support customizable smart zone ranges, include options to trigger specific actions when the electronic device 102 is in a smart zone, and enable users to create personalized smart zone profiles.

Additionally, smart zones may utilize artificial intelligence (AI) to track customer behavior, manage inventory, and optimize operations. Some smart zones may implement features for personalized marketing (e.g., targeted offers, discounts, recommendations), real-time foot traffic monitoring (e.g., optimizing store layout and staffing), smart navigation (e.g., location-based services, digital maps), inventory management (e.g., automated stock tracking, alerts), and so forth, ultimately enhancing customer engagement and business efficiency. Such AI-based operating systems may integrate AI into everyday life for users and improve user experience regarding applications and other elements of the electronic device 102. Smart zones may also be context-aware (e.g., understanding a user's context using always-on context sensing), personal (e.g., customizable to users' preferences), collaborative (e.g., shared between trusted electronic devices), and ubiquitous (e.g., utilized for shopping experiences, navigation, attention tracking, and so forth).

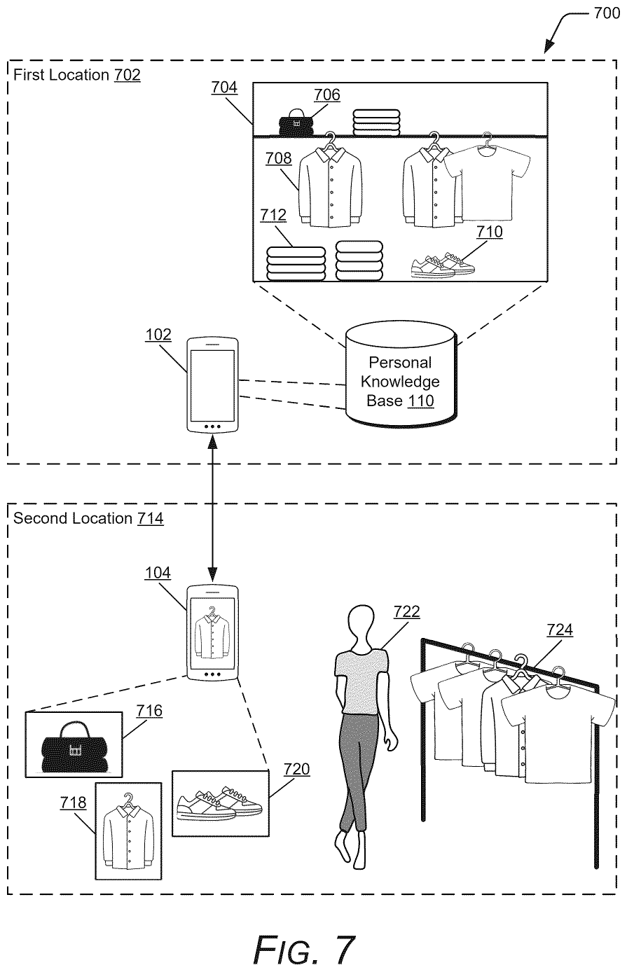

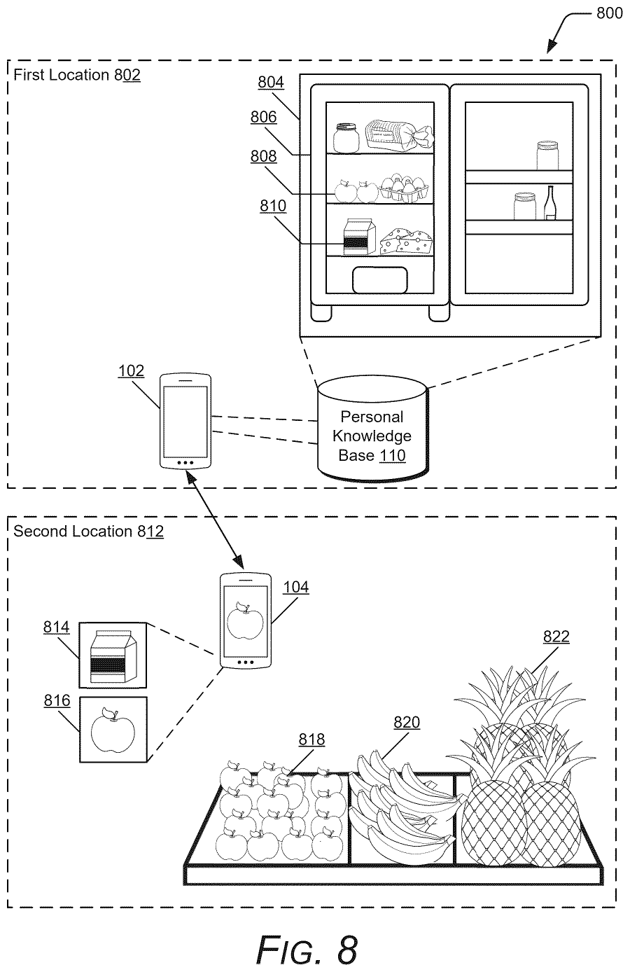

Smart zones may be associated with a particular category of items. For example, as described with reference to FIG. 6, a smart zone may be a clothing store associated with clothing (e.g., the category of items). In another example, as described with reference to FIG. 7, a smart zone may be a grocery store, and more specifically, a produce department of the grocery store. Smart zones may also be specific to other items such as furniture, electronics, utensils, groceries, and so forth. In some examples, the electronic device 102 may detect the electronic device 104 based on the electronic device 104 entering a shopping complex or area with one or more smart zones. That is, the electronic device 102 may be aware of the smart zones that the electronic device 104 frequents, and the electronic device 102 may enable a setting that notifies the electronic device 102 each time the electronic device 104 enters those smart zones.

In some examples, the system 100 may enable these AI-based technologies as described herein with wearable technologies, such as AR glasses or other types of the electronic device 106. For example, a user may wear AR glasses implementing AI features that integrate into the user's physical environment and understand the user's surroundings to provide helpful visualizations. For example, wearing the AR glasses, the user may open their refrigerator and ask an AI platform for recipe suggestions based on the ingredients in the refrigerator. The AR glasses and AI platform may also enable multitasking, e.g., having a video call or adjusting a digital calendar while washing the dishes. Using the AR glasses and AI platform, the user may receive and send messages without reaching for their phone, take hands-on video calls in real-time, stay connected with friends and family without interruptions, receive important notifications and updates without the physical electronic device 102, and unlocking and using applications on the electronic device 102 without the physical electronic device 102, among other features.

In response to detecting the electronic device 104 at the second location, the media management module 120 may recall the visual media from the personal knowledge base 110 using a recall knowledge mechanism. That is, as the media management module 120 determines that the second location is a smart zone associated with grocery items, the media management module 120 may automatically recall visual media from the personal knowledge base 110 that corresponds to that same category of items, i.e., grocery items. For example, the media management module 120 may recall images of an open refrigerator or pantry of the first users' kitchen (e.g., the first location) because those images are relevant to the second location, a grocery store. In another example, if the second location and the smart zone is a bookstore, then the media management module 120 may recall images, videos, and other visual media depicting books and stationary items at a first location (e.g., an office in the first user's house).

The media management module 120 may utilize a machine learning, AI, or classification model that may classify or categorize visual media, and the media management module 120 may recall particular visual media based on such classifications or categorizations. In some implementations, the user's house may be equipped with different smart zones (e.g., kitchen, office, living room, and so forth). Each image or video the user takes may have metadata that indicates which smart zone that image or video was taken in and what category of items that image or video belongs to. For example, if the user takes an image of a bookshelf in their home office, the image may automatically be associated with the office as the smart zone and books as a category of goods based on a machine learning, AI, or classification model. Additionally, or alternatively, the user may manually tag images as being associated with a particular smart zone and category of items. In such cases, when the media management module 120 recalls visual media from the personal knowledge base 110, the media management module 120 may recall specific images or videos tagged to a particular category of items, a particular smart zone, or both.

In some implementations, the media management module 120 may determine that the electronic device 104 is linked or wirelessly connected with one or more other electronic devices, including the electronic device 104, that belong to the first user's trusted group of family members or family devices. In some examples, the media management module 120 may determine a provision of the first user's consent to provide the electronic device 104 and any other trusted electronic device access to the personal knowledge base 110. For example, the media management module 120 may receive user input granting the electronic device 104 access to the personal knowledge base 110.

In some examples, the media management module 120 may recall the visual media based on receiving a request for the visual media from the electronic device 104 when the electronic device 104 is at the second location. For example, when the electronic device 104 enters a given smart zone, the electronic device 104 may send a signal or some other communication to the media management module 120 requesting visual media that is stored in the personal knowledge base 110 and pertinent to the smart zone.

The media management module 120 may communicate (e.g., via the device communication module 114) the visual media to the electronic device 104 based on the items at the first location being in the category that corresponds to the smart zone of the second location. That is, the media management module 120 may communicate images of an open refrigerator to the electronic device 104 if the electronic device 104 is at a grocery store, but not if the electronic device 104 is at a bookstore. In another example, if the media management module 120 detects the electronic device 104 at a bookstore, then the media management module 120 may communicate images of bookshelves in the first user's office, but may refrain from communicating images of the first user's open refrigerator. By communicating in this way, the electronic device 102 may share pertinent visual media instead of the user of the electronic device 104 needing to sort through large amounts of irrelevant data for one image or video they are looking for.

In some implementations, the electronic device 102 and the electronic device 104 may be the same electronic device. In such cases, a user may obtain and store the visual media of one or more items using the electronic device 102. For example, the user may use the image capture module 112 to take a picture of an open refrigerator in the user's kitchen (e.g., a first location). The same user may then go to the grocery store to shop for groceries and recall the visual media from the personal knowledge base 110 via the electronic device 102. In such cases, the visual media may be displayed to the user on the electronic device 102, for example, via a user interface of an application. By way of example, a user may be at home at a first time instance. The user's mobile device (e.g., an electronic device 102) may capture images of various household items using a camera or AR glasses worn by the user. The images may be stored in the personal knowledge base 110 without needing any user intervention. Later, when this same user is at a smart zone (e.g., a store) at a second time instance, the visual information about smart zone specific inventory may be recalled and shown on a display of the mobile device.

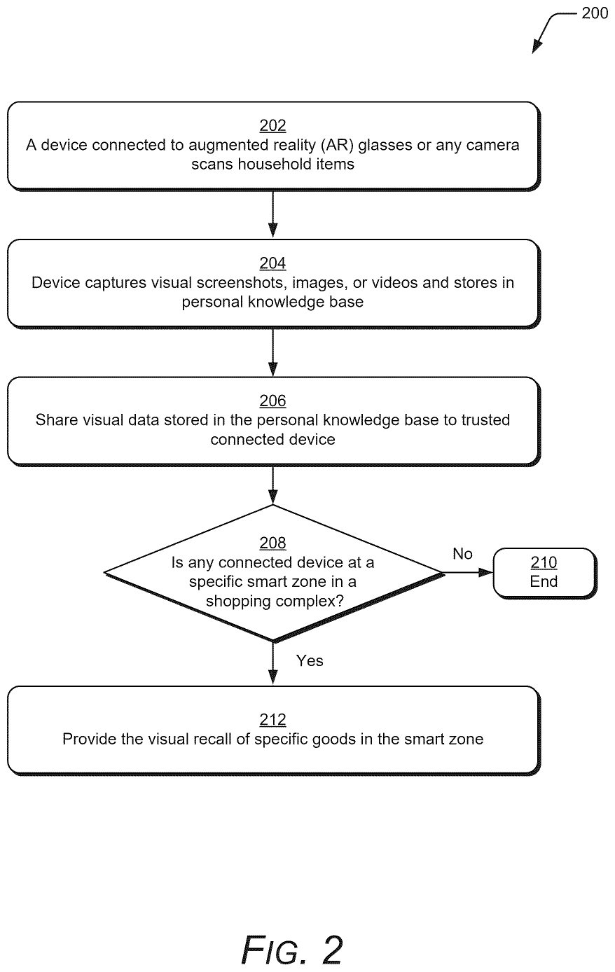

FIG. 2 illustrates an example operation 200 implementing the techniques discussed herein. The operation 200 may be implemented in or otherwise supported by the system 100, as described with reference to FIG. 1. For example, the operation 200 may enable an electronic device 102 to communicate visual media for electronic devices, such as an electronic device 104, that are located at a smart zone. The operation 200 illustrates an example of the techniques discussed herein, though steps of the operation 200 may be performed in different orders for different examples of items and smart zones.

At 202, a device (e.g., an electronic device 102) connected to AR glasses or any camera capturing device (e.g., an image capture module 112) may scan a first location (e.g., a user's house) for one or more household items. For example, a user may use the AR glasses or a camera that is wirelessly connected to the device to scan an individual room or area of the first location for the one or more household items. The household items may include clothing, grocery items, cleaning supplies, books and stationary items, and so forth. In some examples, the first location may include all or part of the user's house, workplace, or other location.

At 204, the device may capture visual screenshots, images, or videos of the household items and store the visual media in a personal knowledge base of the device. Each image, video, or other visual media that is stored may be associated with an item or category of items such that the visual media may later be associated with a smart zone.

At 206, the device may share the visual media stored in the personal knowledge base to a trusted, connected device. The connected device may be one of a group of trusted devices (e.g., family devices). In such an example, a first user of the device may be a first family member that is at home, and a second user of the connected device may be a second family member that is out shopping for the household items. To share the visual media, the device may recall the visual media from the personal knowledge base.

At 208, while providing the connected device access to the personal knowledge base, the device may determine if the connected device is located at a specific smart zone in a shopping complex. A smart zone may correspond to a category of items, such as grocery items, cleaning supplies, clothing, and so forth. In some examples, the connected device may send a request to the device indicating that the connected device is located at a smart zone. Additionally, or alternatively, the device may automatically detect that the connected device is located at the smart zone.

At 210, if the connected device is not located at a specific smart zone, then the communications between the devices may end, and the device may refrain from sharing specific visual media with the connected device.

At 212, if the connected device is located at a specific smart zone, then the device may recall visual media associated with specific items associated with the smart zone and provide or share the recalled visual media to the connected device. For example, if the smart zone is a bookstore, then the device may recall and share images, videos, or other visual media of books to the connected device. If the smart zone is a grocery store, then the device may recall and share images, videos, and other visual media of grocery items (e.g., in a pantry or refrigerator) to the connected device.

FIG. 3 illustrates an example operation 300 implementing the techniques discussed herein. The operation 300 may be implemented in or otherwise supported by the system 100, as described with reference to FIG. 1. For example, the operation 300 may enable an electronic device 102 to recall and display visual media for electronic when the electronic device 102 is located at a smart zone. The operation 300 illustrates an example of the techniques discussed herein, though steps of the operation 300 may be performed in different orders for different examples of items and smart zones.

At 302, a device (e.g., an electronic device 102) connected to AR glasses or any camera capturing device (e.g., an image capture module 112) may scan a first location (e.g., a user's house) for one or more household items. For example, a user may use the AR glasses or a camera that is wirelessly connected to the device to scan an individual room or area of the first location for the one or more household items. The household items may include clothing, grocery items, cleaning supplies, books and stationary items, and so forth. In some examples, the first location may include all or part of the user's house, workplace, or other location.

At 304, the device may capture visual screenshots, images, or videos of the household items and store the visual media in a personal knowledge base of the device. Each image, video, or other visual media that is stored may be associated with an item or category of items such that the visual media may later be associated with a smart zone.

At 306, the device may determine that it is located at a specific smart zone in a shopping complex. A smart zone may correspond to a category of items, such as grocery items, cleaning supplies, clothing, and so forth. By way of example, the device may automatically detect that it is located at the smart zone based on some location services.

At 308, if the device is not located at a specific smart zone, then the device may refrain from recalling any visual media from the personal knowledge base and displaying the visual media via a user interface of the device.

At 310, if the device is located at a specific smart zone, then the device may recall visual media of specific items associated with the smart zone and display the visual media via a user interface of the device. For example, if the smart zone is a bookstore, then the device may recall and display images, videos, or other visual media of books such that the user may reference the visual media while they are shopping. If the smart zone is a grocery store, then the device may recall and display images, videos, and other visual media of grocery items (e.g., in a pantry or refrigerator).

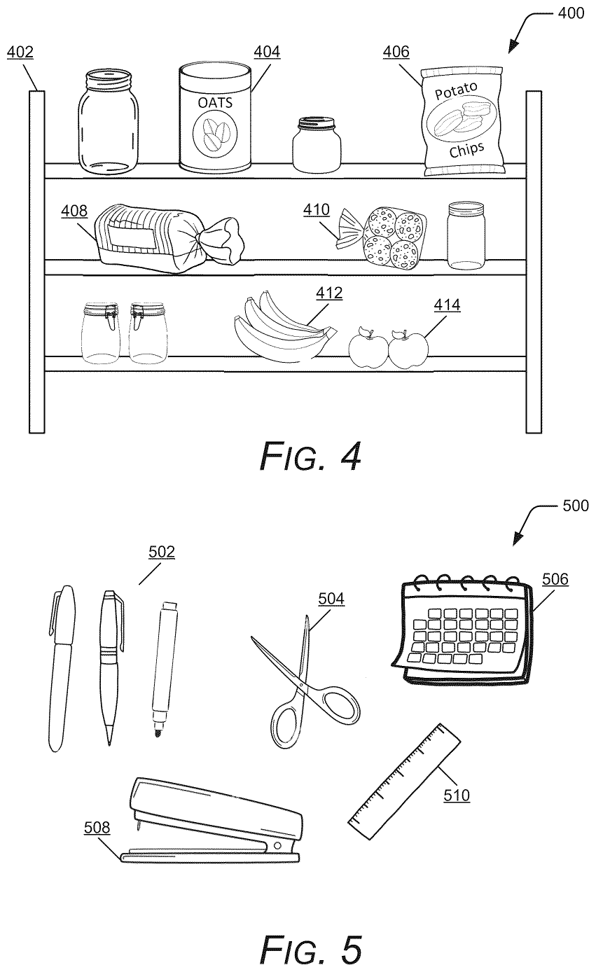

FIG. 4 illustrates an example of items 400 implementing the techniques discussed herein. As described herein, an electronic device (e.g., a smartphone or other mobile device) may obtain visual media of the items 400 at a first location. In the example of FIG. 4, the first location of the items 400 may be a shelf 402, which may be located in a pantry or a cupboard of a user's kitchen, for example. The items 400 may include grocery items including oats 404, potato chips 406, bread 408, cookies 410, bananas 412, and apples 414, among other grocery items. In some examples, the electronic device may capture images, videos, or other visual media of the items 400 individually or collectively. That is, the electronic device may take or receive (e.g., from an external electronic device such as AR glasses or a camera) and store images of each of the items 400 individually, or the electronic device may take or receive and store images of the entire shelf 402, such that a user may be able to discern what is missing from the shelves, for example.

The electronic device may store the visual media of the items 400 at a personal knowledge base, and the electronic device may recall the visual media if it detects a second, connected electronic device located at a relevant smart zone. For example, if the electronic device detects a second electronic device at a grocery store, then the electronic device may provide the visual media of the items 400 and provide the visual media to the second electronic device such that the user of the second electronic device knows what groceries they need to purchase.

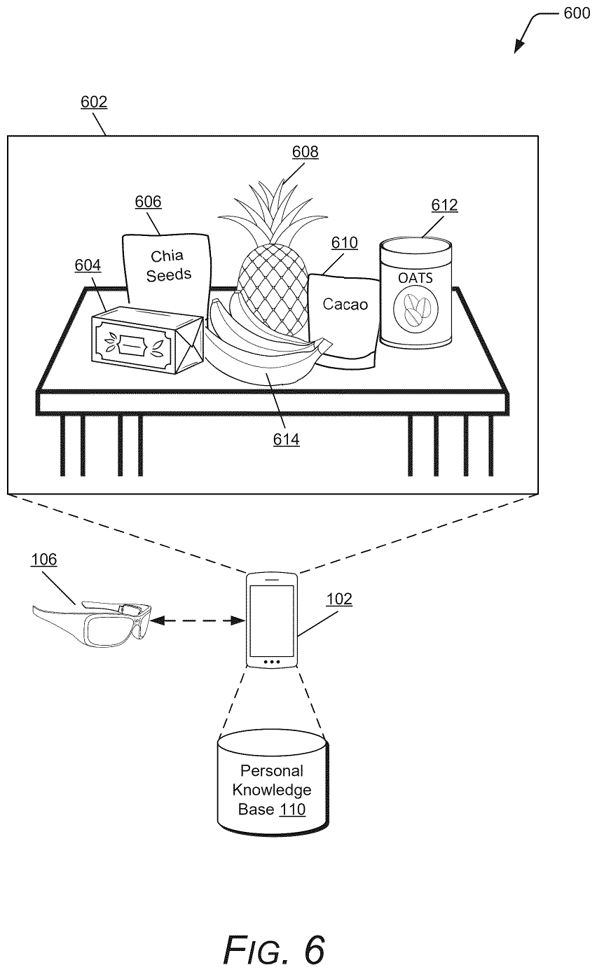

FIG. 5 illustrates example an example of items 500 implementing the techniques discussed herein. As described herein, an electronic device (e.g., a smartphone or other mobile device) may obtain visual media of the items 500 at a first location. In the example of FIG. 5, the first location of the items 500 may be an office or other workspace of a user's house, for example. The items 500 may include stationary and office supplies such as pens 502, scissors 504, a calendar 506, a stapler 508, and a ruler 510, among other stationary and office supplies. In some examples, the electronic device may capture images, videos, or other visual media of the items 500 individually or collectively. That is, the electronic device may take or receive (e.g., from an external electronic device such as AR glasses or a camera) and store images of each of the items 500 individually, or the electronic device may take or receive and store images of all of the items 500 together, such that a user may be able to discern what is missing from the stationary and office supplies, for example.

The electronic device may store the visual media of the items 500 at a personal knowledge base, and the electronic device may recall the visual media if it detects a second, connected electronic device located at a relevant smart zone. For example, if the electronic device detects a second electronic device at a stationary and office supplies store, then the electronic device may provide the visual media of the items 500 and provide the visual media to the second electronic device such that the user of the second electronic device knows what supplies they need to purchase.

FIG. 6 illustrates an example of visual media storage 600 implementing the techniques discussed herein. As described herein, a user may communicate visual media to electronic devices located in a zone based on a category of items associated with the smart zone.

An electronic device 102 (e.g., a smartphone or other mobile device) may be connected to an electronic device 106, which may be AR glasses, a camera, a smartwatch, or another electronic device capable of capturing images, videos, and other visual media. The electronic device 102, itself or via the electronic device 106, may monitor or scan a first location for one or more items (e.g., items 400 or items 500 as described with reference to FIGS. 4 and 5). For example, a household may shop for groceries once a week. In anticipation of the shopping trip, a first user may use at least one of the electronic device 102 or the electronic device 106 to monitor the first user's kitchen (e.g., a first location) for grocery items. The user may wear the electronic device 106 or use a camera of the electronic device 102 and open the refrigerator, pantry, cupboards, and drawers in the kitchen to capture visual media including images or videos of the first user's grocery items. In the example of FIG. 6, the visual media may include an image 602, which may depict items such as tea 604, chia seeds 606, a pineapple 608, cacao 610, oats 612, and bananas 614, and so forth.

If the image 602 was captured by the electronic device 106, the electronic device 106 may send the image 602 to the electronic device 102. The electronic device 102 may store the image 602 in a personal knowledge base 110.

In some implementations, a second user (e.g., another member of the household) may be shopping for groceries at the grocery store. Instead of relying on a grocery list or memory, the second user, via an electronic device (e.g., an electronic device 104 as described with reference to FIG. 1) may receive the image 602 from the electronic device 102. That is, upon detecting that the second user and their electronic device are located at the grocery store, which may be a smart zone, the electronic device 102 may recall the visual media from the personal knowledge base 110 to determine whether any of the visual media depicts items associated with the smart zone. In the example of FIG. 6, because the image 602 depicts grocery items and the second user and their electronic device are located at a grocery store, the electronic device 102 may provide the image 602 to the second user. In this way, the second user may use the image 602 to identify what groceries are missing from their kitchen and shop accordingly.

FIG. 7 illustrates an example of visual media recall 700 implementing the techniques discussed herein. As described herein, a user may communicate visual media to electronic devices located in a zone based on a category of items associated with the smart zone.

In the example of FIG. 7, a first user may plan to go shopping for new clothing for their household. The first user may use an electronic device 102 (e.g., in some cases using an external camera capturing device such as an electronic device 106) take images or videos of items at a first location 702. For example, the first location 702 may be a closet, which may include items such as a purse 706, a dress shirt 708, a pair of shoes 710, pants 712, and so on. The first user may use the electronic device 102 to take an image 704 or a video of the entire closet and/or of individual items in the closet. The electronic device 102 may store the images or videos in a personal knowledge base 110 of the electronic device 102. In some examples (e.g., based on user tags or an AI or other classification model), metadata corresponding to each image or video may be associated with a category of goods (e.g., clothing) and a smart zone within the first user's house (e.g., a closet), which may assist the electronic device 102 in later recalling the visual media.

The first user or a second user using an electronic device 104 may go shopping for the new clothing at a second location 714, which may be a clothing store in a mall. The second location 714 may also be a smart zone, which may be digitally-enabled to create an interactive shopping experience for the second user. The smart zone may include the entire clothing store or a specific section or area of the clothing store (e.g., the women's department), and may be associated with the smart zone of the first location 702 (e.g., the first user's closet). For example, the second location 714 may include a mannequin 722, clothing racks 724, and other elements indicating that the second location 714 sells clothing and would therefore be relevant to the images taken at the first location 702. Based on the second location 714 corresponding to a category of items also associated with the items at the first location 702 (e.g., clothing), the electronic device 102 may detect the electronic device 104 at the second location 714. That is, the electronic device 102 may be capable of detecting when the electronic device 104 is at a smart zone associated with clothing, i.e., the clothing store.

Based on detecting the electronic device 104 at the second location 714, the electronic device 102 may recall the image(s) or video(s) taken of the closet from the personal knowledge base 110. Additionally, or alternatively, the electronic device 104 may request the images from the electronic device 102, which may trigger the electronic device 102 to recall the images.

The electronic device 102 may communicate the images to the electronic device 104 so long as the items in the images relate to the smart zone of the second location 714. For example, the electronic device 102 may recall an image 716 of the purse 706, an image 718 of the dress shirt 708, and an image 720 of the pair of shoes 710. The electronic device 102 may share images of the closet and/or the items inside to assist the second user in shopping for clothing. For example, if the second user would like to shop for a new jacket that matches the dress shirt 708, the second user may refer to the images on the electronic device 104 that were sent by the electronic device 102, including the image 716, the image 718, and the image 720.

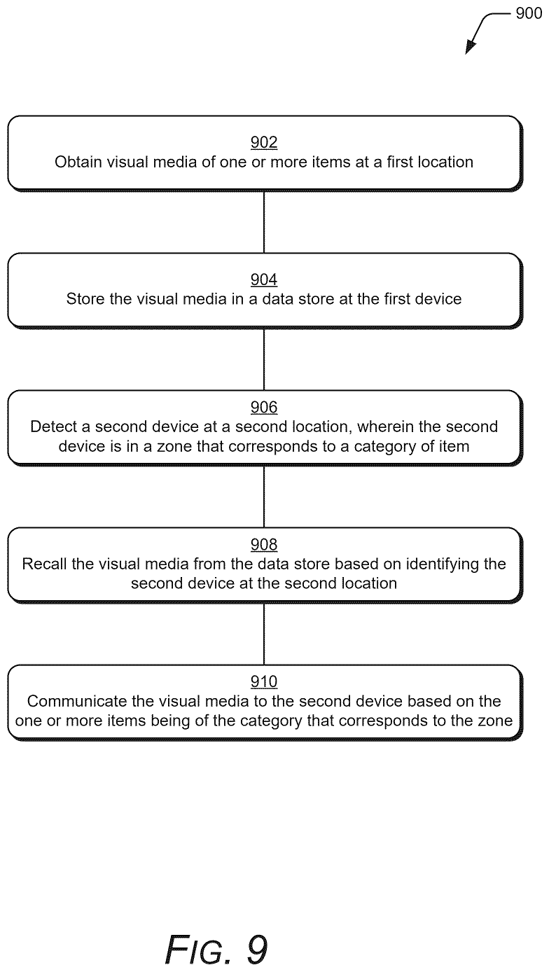

FIG. 8 illustrates an example of visual media recall 800 implementing the techniques discussed herein. As described herein, a user may communicate visual media to electronic devices located in a zone based on a category of items associated with the smart zone.

In the example of FIG. 8, a first user may plan to go grocery shopping for their household. The first user may use an electronic device 102 (e.g., in some cases using an external camera capturing device such as an electronic device 106) take images or videos of items at a first location 802. For example, the first location 802 may be an open refrigerator 806, which may include apples 808, milk 810, eggs, cheese, bread, and so on. The first user may use the electronic device 102 to take an image 804 or a video of the entire open refrigerator 806 and/or of individual items in the open refrigerator 806. The electronic device 102 may store the images or videos in a personal knowledge base 110 of the electronic device 102. In some examples (e.g., based on user tags or an AI or other classification model), metadata corresponding to each image or video may be associated with a category of goods (e.g., groceries or food) and a smart zone within the first user's house (e.g., a kitchen), which may assist the electronic device 102 in later recalling the visual media.

The first user or a second user using an electronic device 104 may go shopping for the groceries at a second location 812, which may be a grocery store or a supermarket. The second location 812 may also be a smart zone, which may be digitally-enabled to create an interactive shopping experience for the second user. The smart zone may include the entire grocery store or a specific section or area of the grocery store (e.g., the produce department), and may be associated with the smart zone of the first location 802 (e.g., the first user's kitchen). For example, the second location 812 may include apples 818, bananas 820, pineapples 822, and other elements or items indicating that the second location 812 sells grocery items and would therefore be relevant to the images taken at the first location 802. Based on the second location 812 corresponding to a category of items also associated with the items at the first location 802, the electronic device 102 may detect the electronic device 104 at the second location 812. That is, the electronic device 102 may be capable of detecting when the electronic device 104 is at a smart zone associated with grocery items, i.e., the grocery store.

Based on detecting the electronic device 104 at the second location, the electronic device 102 may recall the image(s) or video(s) taken of the open refrigerator 806 from the personal knowledge base 110. Additionally, or alternatively, the electronic device 104 may request the images from the electronic device 102, which may trigger the electronic device 102 to recall the images.

The electronic device 102 may communicate the images to the electronic device 104 so long as the items in the images relate to the smart zone of the second location 812. For example, the electronic device 102 may recall an image 814 of the milk 810 and an image 816 of the apple 808. The electronic device 102 may share images of the open refrigerator 806 and/or the inside to assist the second user in shopping for groceries. For example, the second user may refer to the images on the electronic device 104 that were sent by the electronic device 102, including the image 814 and the image 816, and decide to purchase a pineapple 822 but not an apple 818.

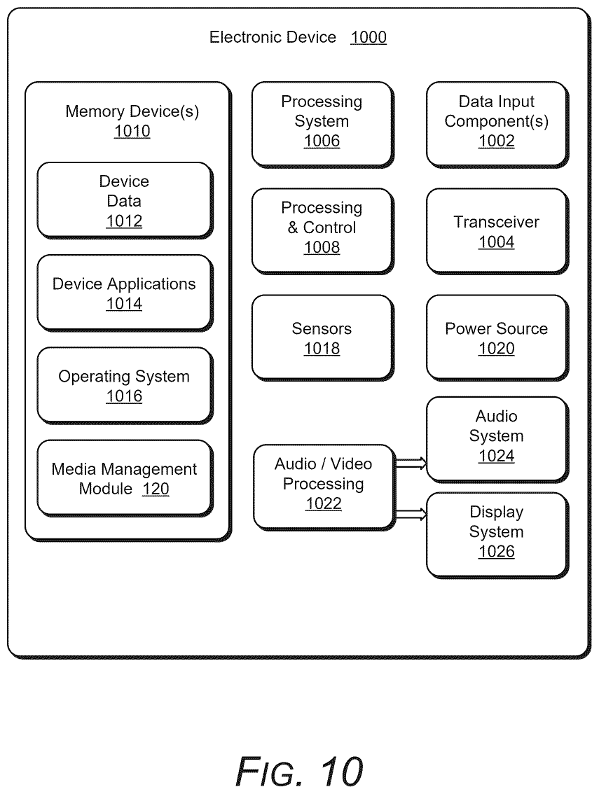

FIG. 9 illustrates an example process 900 for implementing the techniques discussed herein in accordance with one or more embodiments. The process 900 is carried out by electronic devices, a personal knowledge base, an image capture module, device communication modules, and a visual media module, or a combination thereof, such as electronic devices 102, 104, and 106, a personal knowledge base 110, an image capture module 112, device communication modules 114 and 116, and a visual media module 118, of FIG. 1. In some implementations, the process 900 may be implemented in software, firmware, hardware, or combinations thereof. The process 900 is shown as a set of acts and is not limited to the order shown for performing the operations of the various acts.

In the process 900, a first device (e.g., a first electronic device) may obtain visual media of one or more items at a first location (act 902). The first device may be connected to a third device (e.g., a third electronic device) such as AR glasses, a camera, a smartwatch, or so forth, where the third device may capture the visual media and send the visual media to the first device. Alternatively, the first device may capture the visual media (e.g., using the image capture module 112).

The first device may store the visual media in a data store at the first device (act 904). The data store may be a personal knowledge base. The visual media may include images, videos, screenshots, and so forth.

The first device may detect a second device (e.g., a second electronic device) at a second location, where the second location may be a zone (i.e., a smart zone) that corresponds to a category of item (act 906). For example, the zone may be a type of shopping center, mall, or retail store. In some examples, the first device may detect the second device based on the second location being a particular zone.

In response to detecting the second device at the second location, the first device may recall the visual media from the data store (act 908). That is, because the second location is a smart zone, the first device may be triggered to search for and recall pertinent visual media from the personal knowledge base.

Based on the one or more items being of the category that corresponds to the zone, the first device may communicate the visual media to the second device (act 910). That is, when the first device recalls the visual media, the first device may determine whether any of that visual media corresponds to the smart zone. If so, then the first device may share the visual media with the second device. For example, if the smart zone is a grocery store, then the first device may share visual media that depicts grocery items to the second device.

In some examples, the process 900 may be performed in a different order than the order shown for performing the operations of the various acts, or the process 900 may include additional acts or exclude one or more of the acts described herein. For example, the first device may recall the visual media prior to identifying that the second device is at the second location (e.g., based on receiving a request for the visual media from the second device).

FIG. 10 illustrates various components of an example electronic device 1000 that can implement embodiments of the techniques discussed herein. The electronic device 1000 can be implemented as any of the devices described with reference to the previous Figures, such as any type of client device, mobile phone, tablet, computing, communication, entertainment, gaming, media playback, or other type of electronic device. For example, the electronic device 1000 may be an electronic device 102 that includes a media management module 120, as described with reference to FIG. 1.

The electronic device 1000 includes one or more data input components 1002 via which any type of data, media content, or inputs can be received such as user-selectable inputs, messages, music, television content, recorded video content, and any other type of text, audio, video, or image data received from any content or data source. The data input components 1002 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 1002 may also include various other input components such as microphones, touch sensors, touchscreens, keyboards, and so forth.

The electronic device 1000 includes communication transceivers 1004 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

The electronic device 1000 includes a processing system 1006 of one or more processors (e.g., any of microprocessors, controllers, and the like) or a processor and memory system implemented as a system-on-chip (SoC) that processes computer-executable instructions. The processing system 1006 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 1008. The electronic device 1000 may further include any type of a system bus or other data and command transfer system that couples the various components within the device. A system bus can include any one or combination of different bus structures and architectures, as well as control and data lines.

The electronic device 1000 also includes computer-readable storage memory devices 1010 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 1010 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The electronic device 1000 may also include a mass storage media device.

The computer-readable storage memory device 1010 provides data storage mechanisms to store the device data 1012, other types of information or data, and various device applications 1014 (e.g., software applications). For example, an operating system 1016 can be maintained as software instructions with a memory device and executed by the processing system 1006 to cause the processing system 1006 to perform various acts. The device applications 1014 may also include a device manager, such as any form of a control application, software application, signal-processing and control module, code that is native to a particular device, a hardware abstraction layer for a particular device, and so on.

The electronic device 1000 can also include one or more device sensors 1018, such as any one or more of an ambient light sensor, a proximity sensor, a touch sensor, an infrared (IR) sensor, accelerometer, gyroscope, thermal sensor, audio sensor (e.g., microphone), and the like. The electronic device 1000 can also include one or more power sources 1020, such as when the electronic device 1000 is implemented as a mobile device. The power sources 1020 may include a charging or power system, and can be implemented as a flexible strip battery, a rechargeable battery, a charged super-capacitor, or any other type of active or passive power source.

The electronic device 1000 additionally includes an audio or video processing system 1022 that generates one or both of audio data for an audio system 1024 and display data for a display system 1026. In accordance with some embodiments, the audio/video processing system 1022 is configured to receive call audio data from the transceiver 1004 and communicate the call audio data to the audio system 1024 for playback at the electronic device 1000. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

In the discussions herein, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Although embodiments of techniques for communicating visual media for devices located in a zone have been described in language specific to features or methods, the subject of the appended claims is not necessarily limited to the specific features or methods described. Rather, the specific features and methods are disclosed as example implementations of techniques for implementing communicating visual media for devices located in a zone. Further, various different embodiments are described, and it is to be appreciated that each described embodiment can be implemented independently or in connection with one or more other described embodiments. Additional aspects of the techniques, features, and/or methods discussed herein relate to one or more of the following:

In some aspects, the techniques described herein relate to a first device, including: at least one memory; and at least one processor coupled with the at least one memory and configured to cause the first device to: obtain visual media of one or more items at a first location; store the visual media in a data store at the first device; detect a second device at a second location, wherein the second location is a zone that corresponds to a category of item; recall the visual media from the data store based on detecting the second device at the second location; and communicate the visual media to the second device based on the one or more items being of the category that corresponds to the zone.

In some aspects, the techniques described herein relate to a first device, wherein the at least one processor is configured to cause the first device to: receive a request for the visual media from the second device based on the second device being at the second location; and recall the visual media for communication to the second device based on the request.

In some aspects, the techniques described herein relate to a first device, wherein the at least one processor is configured to cause the first device to capture the visual media at the first location.

In some aspects, the techniques described herein relate to a first device, wherein the at least one processor is configured to cause the first device to monitor the first location for the one or more items.

In some aspects, the techniques described herein relate to a first device, wherein the at least one processor is configured to cause the first device to identify that at least the second device is wirelessly connected to the first device, wherein at least the first device and the second device comprise a group of trusted devices.

In some aspects, the techniques described herein relate to a first device, wherein the at least one processor is configured to cause the first device to receive a user input granting access to the data store to the second device.

In some aspects, the techniques described herein relate to a first device, wherein the first device is connected to a third device capable of capturing the visual media, and wherein, to obtain the visual media, the at least one processor is configured to cause the first device to receive the visual media from the third device.

In some aspects, the techniques described herein relate to a first electronic device, wherein the third device comprises at least one of AR glasses or a camera.

In some aspects, the techniques described herein relate to a first electronic device, wherein the visual media comprises at least one of an image, a screenshot, or a video.

In some aspects, the techniques described herein relate to a method comprising: obtaining visual media of one or more items at a first location; storing the visual media in a data store at the first device; detecting a second device at a second location, wherein the second location is a zone that corresponds to a category of item; recalling the visual media from the data store based on detecting the second device at the second location; and communicating the visual media to the second device based on the one or more items being of the category that corresponds to the zone.

In some aspects, the method further comprises: receiving a request for the visual media from the second device based on the second device being at the second location; and recall the visual media for communication to the second device based on the request.

In some aspects, the method further comprises causing the first device to capture the visual media at the first location.

In some aspects, the method further comprises causing the first device to monitor the first location for the one or more items.

In some aspects, the method further comprises identifying that at least the second device is wirelessly connected to the first device, wherein at least the first device and the second device comprise a group of trusted devices.

In some aspects, the method further comprises causing the first device to receive a user input granting access to the data store to the second device.

In some aspects of the method, the first device is connected to a third device capable of capturing the visual media, and wherein, to obtain the visual media, the method further comprises receiving the visual media from the third device.

In some aspects, the techniques described herein relate to a first electronic device, wherein the third device comprises at least one of AR glasses or a camera.

In some aspects, the techniques described herein relate to a first electronic device, wherein the visual media comprises at least one of an image, a screenshot, or a video.

In some aspects, the techniques described herein relate to a processor, including: at least one controller coupled with at least one memory and configured to cause the processor to: obtain visual media of one or more items at a first location; store the visual media in a data store at the first device; detect a second device at a second location, wherein the second location is a zone that corresponds to a category of item; recall the visual media from the data store based on detecting the second device at the second location; and communicate the visual media to the second device based on the one or more items being of the category that corresponds to the zone.

In some aspects, the techniques described herein relate to a processor, wherein the at least one controller is further configured to cause the processor to: receive a request for the visual media from the second device based on the second device being at the second location; and recall the visual media for communication to the second device based on the request.

In some aspects, the techniques described herein relate to a processor, wherein the at least one controller is further configured to cause the processor to capture the visual media at the first location.

In some aspects, the techniques described herein relate to a processor, wherein the at least one controller is further configured to cause the processor to monitor the first location for the one or more items.

In some aspects, the techniques described herein relate to a processor, wherein the at least one controller is further configured to cause the processor to identify that at least the second device is wirelessly connected to the first device, wherein at least the first device and the second device comprise a group of trusted devices.

In some aspects, the techniques described herein relate to a processor, wherein the at least one controller is further configured to cause the processor to receive a user input granting access to the data store to the second device.

In some aspects, the techniques described herein relate to a processor, wherein the processor is connected to a third device capable of capturing the visual media, and wherein, to obtain the visual media, the at least one controller is further configured to cause the processor to receive the visual media from the third device.

In some aspects, the techniques described herein relate to a first electronic device, wherein the third device comprises at least one of AR glasses or a camera.

In some aspects, the techniques described herein relate to a first electronic device, wherein the visual media comprises at least one of an image, a screenshot, or a video.

In some aspects, the techniques described herein relate to a device, including: at least one memory; and at least one processor coupled with the at least one memory and configured to cause the device to: obtain visual media of one or more items at a first location; store the visual media in the data store at the device; detect the device at a second location, wherein the second location is a zone that corresponds to a category of item; recall the visual media from the data store based on detecting the device at the second location; and display the visual media at the device based on the one or more items being of the category that corresponds to the zone.

In some aspects, the techniques described herein relate to a device, wherein, to obtain the visual media, the at least one processor is further configured to cause the device to capture the visual media at the first location.

What is claimed is:

1. A first device, comprising:
at least one memory; and
at least one processor coupled with the at least one memory and configured to cause the first device to:
obtain visual media of one or more items at a first location;
store the visual media in a data store at the first device;
detect a second device at a second location, wherein the second location is a zone that corresponds to a category of item;
recall the visual media from the data store based on detecting the second device at the second location; and
communicate the visual media to the second device based on the one or more items being of the category that corresponds to the zone.

2. The first device of claim 1, wherein the at least one processor is further configured to cause the first device to:
receive a request for the visual media from the second device based on the second device being at the second location; and
recall the visual media for communication to the second device based on the request.

3. The first device of claim 1, wherein, to obtain the visual media, the at least one processor is further configured to cause the first device to capture the visual media at the first location.

4. The first device of claim 1, wherein, to obtain the visual media, the at least one processor is further configured to cause the first device to monitor the first location for the one or more items.

5. The first device of claim 1, wherein the at least one processor is further configured to cause the first device to identify that at least the second device is wirelessly connected to the first device, wherein at least the first device and the second device comprise a group of trusted devices.

6. The first device of claim 1, wherein the at least one processor is further configured to cause the first device to receive a user input granting access to the data store to the second device.

7. The first device of claim 1, wherein the first device is connected to a third device capable of capturing the visual media, and wherein, to obtain the visual media, the at least one processor is further configured to cause the first device to receive the visual media from the third device.

8. The first device of claim 7, wherein the third device comprises at least one of augmented reality (AR) glasses or a camera.

9. The first device of claim 1, wherein the visual media comprises at least one of an image, a screenshot, or a video.

10. A method at a first device, the method comprising:
obtaining visual media of one or more items at a first location;
storing the visual media in a data store at the first device;
detecting a second device at a second location, wherein the second location is a zone that corresponds to a category of item;
recalling the visual media from the data store based on detecting the second device at the second location; and
communicating the visual media to the second device based on the one or more items being of the category that corresponds to the zone.

11. The method of claim 10, further comprising:
receiving a request for the visual media from the second device based on the second device being at the second location; and
recalling the visual media for communication to the second device based on the request.

12. The method of claim 10, wherein obtaining the visual media further comprises capturing the visual media at the first location.

13. The method of claim 10, wherein obtaining the visual media further comprises monitoring the first location for the one or more items.

14. The method of claim 10, further comprising identifying that at least the second device is wirelessly connected to the first device, wherein at least the first device and the second device comprise a group of trusted devices.

15. The method of claim 10, further comprising receiving a user input granting access to the data store to the second device.

16. The method of claim 10, wherein the first device is connected to a third device capable of capturing the visual media, and wherein obtaining the visual media further comprises receiving the visual media from the third device.

17. The method of claim 16, wherein the third device comprises at least one of augmented reality (AR) glasses or a camera.

18. The method of claim 10, wherein the visual media comprises at least one of an image, a screenshot, or a video.

19. A device, comprising:
at least one memory; and
at least one processor coupled with the at least one memory and configured to cause the device to:
obtain visual media of one or more items at a first location;
store the visual media in a data store at the device;
detect the device at a second location, wherein the second location is a zone that corresponds to a category of item;
recall the visual media from the data store based on detecting the device at the second location; and
display the visual media at the device based on the one or more items being of the category that corresponds to the zone.

20. The device of claim 19, wherein, to obtain the visual media, the at least one processor is further configured to cause the device to capture the visual media at the first location.
